(19) United States
(12) Patent Application Publication
(10) Pub. No.: US 2004/0111237 A1
(43) Pub. Date: Jun. 10, 2004

(54) Method for estimating residual life of industrial equipment

(75) Inventor: Pieter-Jan Vlok, Krakow (PL)

Correspondence Address: Michael M. Rickin, Esq., ABB Inc., Legal Department - 4U6, 29801 Euclid Avenue, Wickliffe, OH, 44092-1832, US

(73) Assignee: ABB Inc.

(21) Appl. No.: 10/309,905

(22) Filed: Dec. 4, 2002

(51) Int. Cl. G06F 11/30

(52) U.S. Cl. 702/183

(57) ABSTRACT

In a method for estimating the residual life of machinery statistically by calculating conditional expectations, it is disclosed that different statistical approaches are required for defining the behavior of failure processes related to repairable and non-repairable systems and that diagnostic information should be combined with event information to significantly improve the accuracy of predictions.

### 1 FIELD OF THE INVENTION

This invention relates to industrial equipment on which diagnostic inspections are performed such as rotating machinery and more particularly to a method for estimating the residual life, μ(x) or μ(t) of such equipment.

### 2 THE PRIOR ART

“I know my machine is not in good condition, but when can I expect it to fail?” This question on the residual life of equipment is asked every day in manufacturing industries worldwide but the method currently used in practice provides surprisingly few accurate answers to the question. Thus, accurate information about the residual life of machines is extremely useful in practice since it could prevent future, unexpected failures of the machines.

Residual life is defined as the difference between the conditional expectation of an event and the current operating time, within statistical bounds. This is determined in practice by observing several interarrival times of a machine, Xᵢ, and calculating a parametric function for its Force of Mortality (FOM) [see Ascher, H E and Feingold, H (1984), Repairable systems reliability: Modeling, inference, misconceptions and their causes, Chapters 1, 2 and 3, Marcel Dekker (Ascher and Feingold)], h(x) on the interarrival times from which the conditional expectation is calculated. This method is simple but often yields broad, inaccurate results that cannot be used with authority. Even though this approach is theoretically correct, it only applies to special cases and cannot be used generally to analyze failure time data.

Different machines have different failure behaviors and the method outlined above does not apply for both different machines and different failure behaviors simultaneously. A failure of a machine occurs when an instant of unsatisfactory performance arises on that machine because of a failure event such as for example destructive breakdown of the machine. A destructive breakdown of the machine is not necessarily required to record a failure event on a machine as what is an instant of unsatisfactory performance on the machine depends on the definition of unsatisfactory performance for every situation. For example, a failure on an electrical motor could be recorded whenever it causes a production interruption, or it causes a certain reduction in production quality or it exceeds a particular diagnostic measurement.

In some cases, machines or components, such as for example, bearings, seals and gears, are run until failure and then replaced by completely new units while the old unit is discarded. These machines or components that are replaced when by new units the first time they fail are referred to as non-repairable systems. Modeling of non-repairable systems involve characterizing its FOM.

Larger machines, such as for example, electrical motors, gearboxes and pumps, are usually repaired after failure to the same state as just prior to failure and reintroduced into operation. These larger machines that are repaired after a failure are referred to as repairable systems. As is described by Ascher and Feingold the modeling of repairable systems involve characterizing its Rate of Occurrence of Failure (ROCOF) which is the time derivative of the expected number of failures up to a certain instant.

From a statistical viewpoint it is fundamentally incorrect to treat data from non-repairable and repairable systems in the same manner. In most cases, non-repairable systems produce data where the interarrival times are independent and identically distributed, i.e. Xᵢ's are random. Repairable systems mostly generate data where the interarrival times have a tendency to increase or decrease with time. In practice the differences in the types of data from non-repairable and repairable systems are frequently totally ignored.

Another important reason for the inaccurate results of the method above is because no concomitant information about the length of interarrival times (Xᵢi's) is available. For example, if several events of a bearing is observed for a system of 100±20 days but one event of only 30 days, there is probably contamination in the data set which could have been explained by concomitant information such as condition monitoring. Including an observation such as the one of only 100 days, often severely influences the results.

Lastly consider the method currently used in practice. In that method only data generated from one machine or system is used and before statistical modeling is possible, time has to pass until a sufficient number of events is available (typically 10). This shortcoming causes the method to be unappealing to maintenance practitioners since an immediately implementable solution is desired.

To solve the problems described above with the method currently in use, there is invented a method for estimating the residual life of industrial equipment that is based on actuarial statistics. This method is analogous to the methodology used by insurance companies that have to estimate the residual life of a client at his or her current age in order to set appropriate life insurance premiums. These companies compile data of the ages of people (with certain similarities) at death and their associated life styles, e.g. the number of cigarettes smoked per day, number of beers drank per week, stress levels, etc. This data is represented by a Proportional Intensity Model (PIM) and it is hence possible to estimate the residual life of a new client at a certain age with a certain life style.

The methodology of the present invention to estimate the residual life for machines makes use of the ages of machines at failure and associated diagnostic information that was collected during the machine's lifetime. Data of similar failed machines is compiled and a PIM specially developed for reliability data is fitted to observations. From that PIM it is possible to estimate the residual life of a machine currently in operation, at a certain age and with certain diagnostic measurements.

The present invention recognizes the fact that data produced from non-repairable systems should be treated differently than that of repairable systems. It further includes concomitant information such as condition monitoring information in residual life estimates to avoid possible contamination of data. It lastly also allows (because of the inclusion of covariates) for statistical stratification of data which implies that data from similar nominally similar machines could be used to estimate the residual life of any specific machine. This aspect allows for the invention to be implementable virtually immediately in most situations.

### SUMMARY OF THE INVENTION

A method for estimating the residual life of rotating machinery within statistical bounds based on event data and corresponding diagnostic measurements. The method comprises:

processing of formulation of combined Proportional Intensity Models (PIMs) in the form of Force of Mortality (FOM) for non-repairable systems and Rate of Occurrence of Failure (ROCOF) for repairable systems;

processing of formulation of said Force of Mortality (FOM) for non-repairable systems or processing of formulation of said Rate of Occurrence of Failure (ROCOF) for repairable systems;

deriving the probability density from said Force of Mortality (FOM) or said Rate of Occurrence of Failure (ROCOF); and

calculating a conditional expectation of a failure event of said rotating machinery within statistical bounds from the probability density.

### DESCRIPTION OF THE DRAWING

FIG. 1 shows appropriate time scales to measure life times of systems by means of an example sample path of a failure process.

FIG. 2 is a schematic presentation of the method of the present invention for non-repairable systems and shows that the method as applied to non-repairable systems can be reduced easily to simpler situations.

FIG. 3 is a schematic presentation of the method of the present invention for repairable systems and shows that the method as applied to repairable systems can be reduced easily to simpler situations.

### DESCRIPTION OF THE PREFERRED EMBODIMENT(S)

The objective of the present invention is to model the FOM, h(x) of non-repairable systems and the ROCOF, p(t) of repairable systems. Models for both cases are constructed in such a manner that it allows for sufficient parametric freedom to be able to adapt to most data sets. It is important to note that the parametric freedom is not created by simple arbitrary addition of more parameters but by adding stratified parameters that have physical meaning. For example, both the models for the FOM and ROCOF use only one stratified parameter to allow for acceleration, deceleration or shifts in the time scale.

The models are proposed below in an over-parameterized format to prevent the loss of generality. This format has the advantage however that unwanted parameters can simply be set to zero to suit a particular data set. The model for non-repairable systems are considered first.

Suppose k=1, 2, . . . , w nominally similar system copies with l=1, 2, . . . , n parts in series are studied and the event times on each system are recorded. It is assumed that tests confirmed the validity of non-repairable systems theory on all l parts of each of the k systems. On failure of any of the n parts, all the parts are renewed or replaced before the system is put back into service. The event history of every part in every system is recorded in a qₗ^{k}×2 matrix, consisting of event times,

$${X}_{i}^{{k}_{l}}$$

and event type indicators,

$${C}_{i}^{{k}_{l}}$$

Every system has a similar event history matrix that can be deduced from the part histories, i.e.

$${X}_{i}^{k} = min ( {X}_{i}^{k} ) for l = 1 , 2 , … ,$$

n and Cᵢ^{k} corresponds to the event type of min

$$( {X}_{i}^{{k}_{l}} ) .$$

On each part in each system, mₗ time-dependent covariates are measured, i.e.

$${z}_{i}^{{k}_{l}} = [ {z}_{{i}_{1}}^{{k}_{l}} {z}_{{i}_{2}}^{{k}_{l}} ⋯ {z}_{{i}_{m l}}^{{k}_{l}} ]$$

(“(x)” is suppressed for notational convenience), where x denotes the local time during lifetime i of system k. Event data is categorized in s=1, 2, . . . , r^{l} strata, where r^{l} is the highest stratum of any part l. A general model for the FOM in such a situation is given by,

$$h ( x , θ ) = {\sum }_{l = 1}^{n} {ζ}_{s}^{{k}_{l}} {g}_{s}^{{k}_{l}} ( x , {τ}_{s}^{{k}_{l}} , {ψ}_{s}^{{k}_{l}} ) \cdot λ ( {γ}_{s}^{{k}_{l}} \cdot {z}_{s}^{{k}_{l}} ) + … \\ … {\sum }_{l = 1}^{n} {ζ}_{s}^{{k}_{l}} \cdot v ( {α}_{s}^{{k}_{l}} \cdot {z}_{s}^{{k}_{l}} ) \qquad ( 1 )$$

where θ consists of k, the system copy indicator, s, the current stratum indicator, ζₛ^{k}, a random variable that acts as a frailty in the model that could be system copy- and stratum-specific, gₛ^{k}, a fully parametric baseline function that could be system copy- and stratum-specific, τₛ^{k}, a factor that acts additively on x in gₛ^{k} to represent a time jump or time setback that could be system copy- and stratum specific, ψₛ^{k}, a factor that acts multiplicatively on x in gₛ^{k} to result in an acceleration or deceleration of time that could be system copy- and stratum-specific, λₛ^{k}, a multiplicative functional term that is determined by zₛ^{k} and that acts on gₛ^{k}, vₛ^{k}, an additive functional term determined by zₛ^{k} and zₛ^{k}, a vector of time-dependent covariates.

If the Weibull distribution is used to parameterize the proposed model of the FOM, g for any item l, associated with system k in stratum s becomes,

$${g}_{s}^{{k}_{l}} ( x , θ ) = \frac{{β}_{s}^{{k}_{l}}}{{η}_{s}^{{k}_{l}}} {( \frac{{ψ}_{s}^{{k}_{l}} ( x - {τ}_{s}^{{k}_{l}} )}{{η}_{s}^{{k}_{l}}} )}^{{β}_{s}^{{k}_{l}} - 1} \qquad ( 2 )$$

The functional terms become,

$$\begin{matrix}{λ}_{s}^{{k}_{l}} ( x , θ ) = exp ( {\sum }_{j = 1}^{{m}_{l}} {γ}_{{s}_{j}}^{{k}_{l}} \cdot {z}_{{i}_{j}}^{{k}_{l}} ) & ( 3 ) \\ {v}_{s}^{{k}_{l}} ( x , θ ) = exp ( {\sum }_{j = 1}^{{m}_{l}} {α}_{{s}_{j}}^{{k}_{l}} \cdot {z}_{{i}_{j}}^{{k}_{l}} ) & ( 4 )\end{matrix}$$

The FOM of the entire system is found by substituting the functions above in the proposed FOM model. Regression coefficients can be solved for by maximum likelihood methods. This yields a considerably more accurate representation of the FOM as compared to the FOM resulting from the method of the prior art. This particular representation of the FOM allows for concomitant information as well as multiple system copies which solves some of the short-comings such as the handling of multiple systems copies, allowing for concomitant information and modeling a non-repairable system with appropriate non-repairable system theory described in the method of the prior art.

The repairable case will be considered. Suppose a multiple-component system is considered with parts l=1, 2, . . . , n where the success of the system is dependent on the success of each individual part. Event data from each part in each system is recorded in qₖ^{ₗ}×2 matrices, consisting of event times, Tᵢ^{k}^{ₗ} and event type indicators, Cᵢ^{k}^{ₗ}. Every system has a similar event history matrix that can be deduced from the part histories, i.e. Tᵢ^{k}=min(Tᵢ^{k}^{ₗ}) for l=1, 2, . . . , n and Cᵢ^{k}^{ₗ} corresponds to the event type of min(Tᵢ^{k}^{ₗ}). On each part mₗ time-dependent covariates are measured, i.e.

$${z}^{{k}_{l}} = [ {z}_{1}^{{k}_{l}} {z}_{2}^{{k}_{l}} ⋯ {z}_{{{m}_{l}}_{}}^{{k}_{l}} ]$$

(“(t)” is suppressed for notational convenience), where t refers to the global time of system k. Event data is categorized in s=1, 2, . . . , r^{l} different strata, where r^{l} is the highest stratum of any part l. A general representation of the described system's ROCOF is given by,

$$ρ ( t , θ ) = {\sum }_{l = 1}^{n} {ζ}_{s}^{{k}_{l}} {g}_{s}^{{k}_{l}} ( t , {τ}_{s}^{{k}_{l}} , {ψ}_{s}^{{k}_{l}} ) \cdot λ ( {γ}_{s}^{{k}_{l}} \cdot {z}_{i}^{{k}_{l}} ) … \\ … + {\sum }_{l = 1}^{n} {ζ}_{s}^{{k}_{l}} v ( {α}_{s}^{{k}_{l}} \cdot {z}_{i}^{{k}_{l}} ) \qquad ( 5 )$$

where θ consists of k, the system copy indicator, s, the current stratum indicator, ζₛ^{k}, a random variable that acts as a frailty in the model that could be system copy- and stratum-specific, gₛ^{k}, a fully parametric baseline function that could be system copy- and stratum-specific, Tₛ^{k}, a factor that acts additively on t in gₛ^{k} to represent a time jump or time setback that could be system copy- and stratum-specific, ψₛ^{k}, a factor that acts multiplicatively on t in gₛ^{k} to result in an acceleration or deceleration of time that could be system copy- and stratum-specific, λₛ^{k}, a multiplicative functional term that is determined by zₛ^{k} and that acts on gₛ^{k}, vₛ^{k}, an additive functional term determined by zₛ^{k} and zₛ^{k}, a vector of time-dependent covariates.

If the above model is parameterized by a log-linear function, the baseline function g for any item l, associated with system k in stratum s becomes,

$${g}_{s}^{{k}_{l}} ( t , θ ) = exp ( {Γ}_{s}^{{k}_{l}} + {ψ}_{s}^{{k}_{l}} {Υ}_{s}^{{k}_{l}} ( t - {τ}_{s}^{{k}_{l}} ) ) \qquad ( 6 )$$

The coefficients

$${β}_{s}^{{k}_{l}} , {η}_{s}^{{k}_{l}} , {ψ}_{s}^{{k}_{l}} , and {τ}_{s}^{{k}_{l}}$$

can not be represented as matrices because different systems could be in different strata. The functional terms become,

$$\begin{matrix}{λ}_{s}^{{k}_{l}} ( t , θ ) = exp ( {\sum }_{j = 1}^{{m}_{l}} {γ}_{{s}_{j}}^{{k}_{l}} \cdot {z}_{j}^{{k}_{l}} ) & ( 7 ) \\ {v}_{s}^{{k}_{l}} ( t , θ ) = exp ( {\sum }_{j = 1}^{{m}_{l}} {α}_{{s}_{j}}^{{k}_{l}} \cdot {z}_{j}^{{k}_{l}} ) & ( 8 )\end{matrix}$$

The ROCOF for the entire system is obtained by substituting the above relationships into the proposed model for repairable systems' ROCOF. Regression coefficients can be solved for by maximum likelihood methods. This yields a considerably more accurate representation of the ROCOF as compared to the ROCOF resulting from the method of the prior art. This particular representation of the ROCOF allows for concomitant information as well as multiple system copies which solves some of the shortcomings such as the handling of multiple systems copies, allowing for concomitant information and modeling a non-repairable system with appropriate repairable system theory described in the method of the prior art.

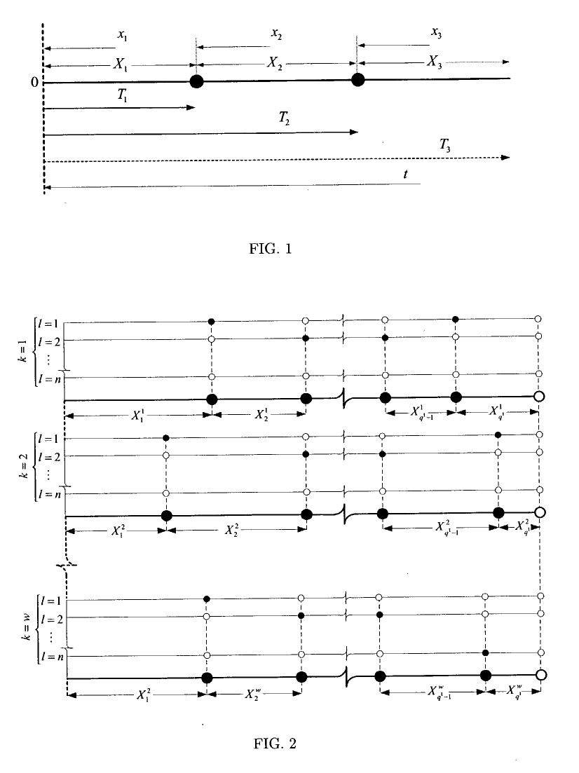

Referring now to FIG. 1, there is shown appropriate time scales to measure life times of systems. It is required to define time scales explicitly because the scale used for non-repairable systems is different than the scale used for repairable systems. The time scales in FIG. 1 are defined by means of an example sample path of a failure process.

Xᵢ, i=1, 2, 3 . . . , refers to the interarrival time between the (i−1)^{th} failure and i^{th} failure. Xᵢ is a random variable with X₀=0. This is referred to as local time and is convenient to use when analyzing non-repairable systems. The real variable xᵢ measures the time elapsed since the most recent failure. Tᵢ, i=1, 2, 3 . . . , measures time from 0 to the i^{th} failure time. Tᵢ is also called the arrival time to the i^{th} failure and is mostly used to analyze repairable systems. This time scale is referred to as global time. Clearly, Tₖ=X₁+X₂+ . . . +Xₖ. From this, a random variable N(t) can be defined as the maximum value of k for which Tₖ<t, i.e. N(t) is the number of failures that have occurred in (0, t]. N(t), t≧0 is the integer valued counting process that includes both the number of failures in (0, t], N(t), and the instants of occurrence, T₁, T₂, . . . ;

A schematic presentation of the general scenario for non-repairable systems is shown in FIG. 2. This scheme shows that the completely general model can be reduced easily to simpler situations. Once the underlying failure process has been defined it is possible to predict the arrival time of the next event. Suppose a system has been in operation for x time units and a maintenance policy exists where the system is replaced preventively at time Xₚ or at failure, whichever comes first. The conditional expectation of Xᵣ₊₁, (where Xᵣ₊₁≦Xₚ), is given by

$$E [ {X}_{r + 1} \vert {X}_{r + 1} \leq {X}_{p} ] = \frac{{\int }_{x}^{{X}_{p}} x \cdot f ( x , θ ) ⅆ x}{{\int }_{x}^{{X}_{p}} f ( x , θ ) ⅆ x} \qquad ( 9 )$$

Hence, the residual life to the (r+1)^{th} failure is expected to be,

μᵣ₊₁=E[Xᵣ₊₁|Xᵣ₊₁≦Xₚ]−x (10)

It is also possible to calculate confidence levels around the residual life estimate. The lower limit, {tilde under (X)}ᵣ₊₁−x, can be obtained by solving numerically for {tilde under (X)}ᵣ₊₁ in,

$$\frac{{\int }_{x}^{{{X}_{∼}}_{r + 1}} f ( x , θ ) ⅆ x}{1 - {\int }_{0}^{x} f ( x , θ ) ⅆ x - {\int }_{{X}_{p}}^{∞} f ( x , θ ) ⅆ x} = 0.025 \qquad ( 11 )$$

Similarly is the upper limit \tilde{X}ᵣ₊₁−x and and can be obtained by solving for \tilde{X}ᵣ₊₁ in,

$$\frac{{\int }_{x}^{{\tilde{X}}_{r + 1}} f ( x , θ ) ⅆ x}{1 - {\int }_{0}^{x} f ( x , θ ) ⅆ x - {\int }_{{X}_{p}}^{∞} f ( x , θ ) ⅆ x} = 0.975 \qquad ( 12 )$$

In the case where there is no preventive maintenance rule, i.e. Xₚ=∞, and it is desired to calculate the residual life shortly after Xᵣ, i.e. x≈0, equation (9) becomes,

$$E [ {X}_{r + 1} ] = \frac{{\int }_{0}^{∞} x \cdot f ( x , θ ) ⅆ x}{{\int }_{0}^{∞} f ( x , θ ) ⅆ x} \qquad ( 13 )$$

and the corresponding residual life to the (r+1)^{th} failure is expected to be,

μᵣ₊₁=E[Xᵣ₊₁−x (14)

The confidence limits now reduce to,

$${\int }_{0}^{{{X}_{∼}}_{r + 1}} f ( x , θ ) ⅆ x = 0.025 \qquad ( 15 )$$

and for the upper limit, \tilde{X}ᵣ₊₁, in,

$${\int }_{x}^{{\tilde{X}}_{r + 1}} f ( x , θ ) ⅆ x = 0.975 \qquad ( 16 )$$

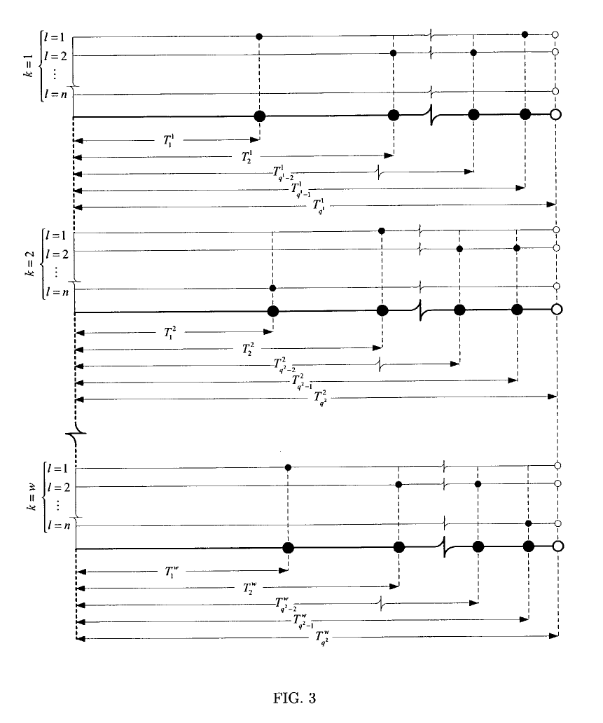

A schematic presentation of the scenario for repairable systems is shown in FIG. 3. This scheme shows that the completely general model can be reduced easily to simpler situations. Once the failure characteristics have been quantified, future failure can be predicted. Suppose a system has been in operation for t time units, where Tᵣ≦t≦Tᵣ₊₁ and it is required to know when the next failure will occur. Further assume that a decision rule applies that the system will not be allowed to operate beyond Tₚ=Tᵣ+v. If the conditional probability density is defined as f(t,θ)=ρ(t,θ)·R(t), the conditional expectation of Tᵣ₊₁ is given by,

$$E [ {T}_{r + 1} \vert {T}_{r + 1} \leq {T}_{p} ] = \frac{{\int }_{t}^{{T}_{p}} s \cdot f ( s , θ ) ⅆ s}{{\int }_{t}^{{T}_{p}} f ( s , θ ) ⅆ s} \qquad ( 17 )$$

Hence, the residual life to the (r+1)^{th} failure is expected to be,

μᵣ₊₁=E[Tᵣ₊₁|Tᵣ₊₁≦Tₚ]−t (18)

It is also possible to calculate confidence levels around the residual life estimate. The lower limit, {tilde under (T)}ᵣ₊₁−t, can be obtained by solving numerically for {tilde under (T)}ᵣ₊₁ in,

$$\frac{{\int }_{t}^{{{T}_{≂}}_{r + 1}} ρ ( s , θ ) ⅆ s}{1 - {\int }_{{T}_{r}}^{t} ρ ( s , θ ) ⅆ s - {\int }_{{T}_{p}}^{∞} ρ ( s , θ ) ⅆ s} = 0.025 \qquad ( 19 )$$

Similarly is the upper limit \tilde{T}ᵣ₊₁−t and and can be obtained by solving for \tilde{T}ᵣ₊₁ in,

$$\frac{{\int }_{x}^{{\tilde{T}}_{r + 1}} ρ ( s , θ ) ⅆ s}{1 - {\int }_{0}^{x} ρ ( s , θ ) ⅆ s - {\int }_{{T}_{p}}^{∞} ρ ( s , θ ) ⅆ s} = 0.975 \qquad ( 20 )$$

Only in very few cases in practice preventive maintenance rules exist for repairable systems. This simplifies the calculations above significantly. Suppose no preventive maintenance rule is applied, i.e. Tₚ=∞, and we would like to calculate the residual life shortly after Tᵣ, i.e. t≈Tᵣ, equation (17) becomes,

$$E [ {T}_{r + 1} ] = {\int }_{{T}_{r}}^{∞} t \cdot {ρ}_{1} ( t ) \cdot R ( {T}_{r} \to t ) ⅆ t \\ = \frac{ln [ ( r + 1 ) {α}_{1} + exp ( {α}_{0} + {α}_{1} {T}_{r} ] - {α}_{0}}{{α}_{1}} \qquad ( 21 )$$

and the corresponding residual life to the (r+1)^{th} failure is expected to be,

μᵣ₊₁=E[Tᵣ₊₁]−Tᵣ (22)

The confidence limits now reduce to,

$${\int }_{{T}_{r}}^{{{T}_{≂}}_{r + 1}} {ρ}_{1} ( s ) \cdot R ( t \to s ) ⅆ s = 0.025 \qquad ( 23 )$$

Similarly is the upper limit \tilde{T}ᵣ₊₁−Tᵣ and and can be obtained by solving for \tilde{T}ᵣ₊₁ in,

$${\int }_{{T}_{r}}^{{\tilde{T}}_{r + 1}} {ρ}_{1} ( s ) \cdot R ( t \to s ) ⅆ s = 0.975 \qquad ( 24 )$$

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A method for estimating the residual life of rotating machinery within statistical bounds based on event data and corresponding diagnostic measurements, comprising:
processing of formulation of combined Proportional Intensity Models (PIMs) in the form of Force of Mortality (FOM) for non-repairable systems and Rate of Occurrence of Failure (ROCOF) for repairable systems;
processing of formulation of said Force of Mortality (FOM) for non-repairable systems or processing of formulation of said Rate of Occurrence of Failure (ROCOF) for repairable systems;
deriving the probability density from said Force of Mortality (FOM) or said Rate of Occurrence of Failure (ROCOF); and
calculating a conditional expectation of a failure event of said rotating machinery within statistical bounds from the probability density.

2. The method of claim 1, wherein the formulation of combined Proportional Intensity Models (PIMs) for non-repairable systems is such that said Force of Mortality (FOM) is given by,
$$h ( x , θ ) = {\sum }_{l = 1}^{n} {ζ}_{s}^{{k}_{l}} {g}_{s}^{{k}_{l}} ( x , {τ}_{s}^{{k}_{l}} , {ψ}_{s}^{{k}_{l}} ) \cdot λ ( {γ}_{s}^{{k}_{l}} \cdot {z}_{s}^{{k}_{l}} ) + … \\ … {\sum }_{l = 1}^{n} {ζ}_{s}^{{k}_{l}} \cdot v ( {α}_{s}^{{k}_{l}} \cdot {z}_{s}^{{k}_{l}} ) \qquad ( 25 )$$
where the summation of terms accommodate multiple component non-repairable systems, ζₛ^{k}^{ₗ} models frailties in the data, gₛ^{k}^{ₗ} (x, τₛ^{k}^{ₗ}, ψₛ^{k}^{ₗ}) is a term quantifying the baseline intensity, λ(γₛ^{k}^{ₗ}·zₛ^{k}^{ₗ}) is a functional term acting multiplicatively on the baseline intensity and v(αₛ^{k}^{ₗ}·zₛ^{k}^{ₗ}) is a functional term allowing for additions to the baseline intensity.

3. The method of claim 1, wherein the formulation of combined Proportional Intensity Models (PIMs) for repairable systems is such that said Rate of Occurrence of Failure (ROCOF) is given by,
$$ρ ( t , θ ) = {\sum }_{l = 1}^{n} {ζ}_{s}^{{k}_{l}} {g}_{s}^{{k}_{l}} ( t , {τ}_{s}^{{k}_{l}} , {ψ}_{s}^{{k}_{l}} ) \cdot λ ( {γ}_{s}^{{k}_{l}} \cdot {z}_{i}^{{k}_{l}} ) … \\ … + {\sum }_{l = 1}^{n} {ζ}_{s}^{{k}_{l}} v ( {α}_{s}^{{k}_{l}} \cdot {z}_{i}^{{k}_{l}} ) \qquad ( 26 )$$
where the summation of terms accommodate multiple component repairable systems,
$${ζ}_{s}^{{k}_{l}}$$
models frailties in the data,
$${g}_{s}^{{k}_{l}} ( x , {τ}_{s}^{{k}_{l}} , {ψ}_{s}^{{k}_{l}} )$$
is a term quantifying the baseline intensity,
$$λ ( {γ}_{s}^{{k}_{l}} \cdot {z}_{s}^{{k}_{l}} )$$
is a functional term acting multiplicatively on the baseline intensity and
$$v ( {α}_{s}^{{k}_{l}} \cdot {z}_{s}^{{k}_{l}} )$$
is a functional term allowing for additions to the baseline intensity.
